(19) United States
(12) Patent Application Publication
(10) Pub. No.: US 2013/0161253 A1
(43) Pub. Date: Jun. 27, 2013

(54) REINFORCEMENT ELEMENT

(71) Applicant: Dean David MARSCHKE, Minnetonka, MN (US)

(72) Inventor: Dean David MARSCHKE, Minnetonka, MN (US)

(73) Assignee: GENERAL ELECTRIC COMPANY, Schenectady, NY (US)

(21) Appl. No.: 13/333,130

(22) Filed: Dec. 21, 2011

(51) Int. Cl. B01D 69/10; B23P 19/04

(52) U.S. Cl. 210/485; 29/428; 210/497.1

(57) ABSTRACT

The present disclosure describes a means to provide structural reinforcement for spiral wound membrane elements. The reinforcement includes a wire and, optionally, an outer wrap. The wire is wrapped around an outer layer of the spiral wound membrane layer and reinforces the spiral wound membrane element. The wire is made from materials that do not deform substantially during sanitization procedures. The outer wrap is wrapped around the wire and limits unsanitary areas of tight tolerance between the perimeter of the spiral wound membrane element and a housing.

### FIELD

The present disclosure relates generally to spiral wound membrane elements and modules.

### BACKGROUND

The following discussion is not an admission that anything discussed below is citable as prior art or common general knowledge.

Typically, a spiral wound membrane element is made by wrapping one or more membrane leaves around a perforated central tube. Each membrane leaf has one edge of a feed carrier sheet placed in a fold of a generally rectangular membrane sheet so that the membrane sheet encompasses the feed spacer sheet on both sides. The fold of the membrane sheet is positioned along a perforated central tube. A permeate carrier sheet is connected at one edge to the perforated central tube and a glue line seals each permeate carrier sheet to an adjacent membrane sheet along three edges, leaving a fourth edge open to the perforated central tube. All of the sheets are wrapped around the perforated central tube.

In use, the spiral wound membrane element is housed in a pressure housing, also referred to as a pressure tube or a pressure vessel. A pressurized feedstock is delivered at an upstream end of the pressure housing and flows into the spiral wound membrane element. Within the spiral wound membrane element, the pressurized feedstock flows through the feed spacer sheets and along the surface of the membrane envelopes. The driving pressures associated with normal operational conditions can stress the structural integrity of the spiral wound membrane element. When the structural integrity is compromised the spiral wound membrane element may axially telescope, or radially expand, which can result in operational inefficiencies or irreparable damage. One structural reinforcement solution is to wrap the spiral wound membrane element in a cage. The cage is often formed of polypropylene netting that is tension wrapped around the spiral wound membrane element. The cage is then fixed to itself, for example by thermal bonding. The cage compresses the spiral wound membrane element, which provides structural support.

Other structural reinforcement solutions include pre-formed cylindrical cages, fiber glass covered elements, heat shrink encased elements and tape-covered elements.

Some specific industries (for example the dairy industry) require sanitary spiral wound membrane elements that meet the requirements of the Sanitary 3A Standards for Crossflow Membrane Modules. Sanitary problems can arise in areas of low flow, also referred to as areas of tight tolerance. One region that typically has tight tolerance is between an inner surface of the pressure housing and the outer surface of the spiral wound membrane element, referred to as the annular space.

### SUMMARY

Areas of tight tolerance have limited fluid access and, therefore, limited flushing to remove solids or provide sanitization solutions. Sanitization solutions are often high temperature fluids, high pH fluids, low pH fluids, enzyme-based fluids, oxidizing fluids or combinations of these sanitization solutions. The sanitization solutions flush and clean the pressure housing and spiral wound membrane elements therein. However, the sanitization solutions can soften, or degrade, the materials of the various structural reinforcement solutions described above. When the soft, or degraded, materials are exposed to the pressures within the pressure housing, the materials deform, which can reduce the structural support provided to the spiral wound membrane element and the physical integrity of the spiral wound membrane element can be compromised.

A reinforcement element for use in spiral wound membrane elements is disclosed in the detailed description below. The reinforcement element is wrapped around an outer layer of a spiral wound membrane element to structurally reinforce the spiral wound membrane element during filtration operations. The reinforcement element comprises a wire. The wire provides a compressive force that structurally reinforces the spiral wound membrane element. The wire is made from materials that are rigid enough to develop or maintain the compressive force during filtration operations without excessive deformation and the materials will not soften or deform by the increased temperature and chemical conditions associated with sanitization procedures. The reinforcement element structurally reinforces the spiral wound membrane element before, during and after sanitization procedures. Further, the reinforcement element may allow for sanitization procedures with higher temperatures, higher pressures and/or stronger chemicals. Higher temperatures, higher pressures and/or stronger chemicals may result in more efficient sanitization procedures, which may increase the operational life of the spiral wound membrane element and decrease the downtime associated with the sanitization procedures.

### BRIEF DESCRIPTION OF THE DRAWINGS

FIG. 1 is a partial cut away, isometric view of a reinforcement element wrapped around a spiral wound membrane element.

### DETAILED DESCRIPTION

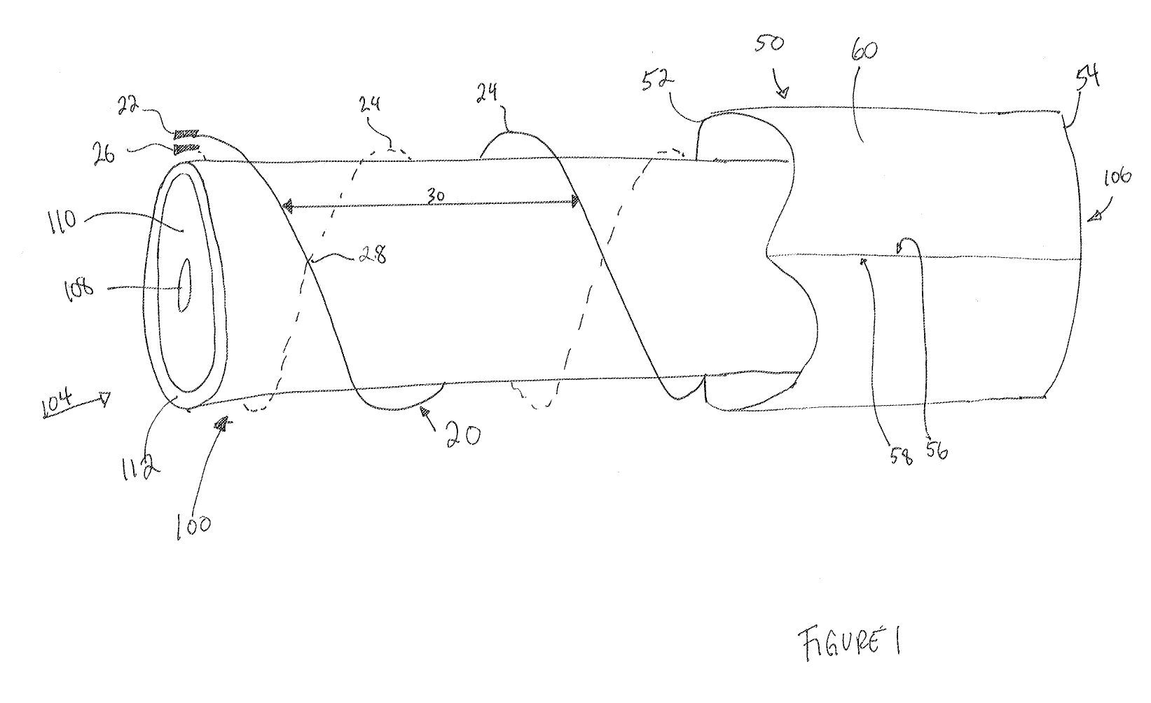

FIG. 1 depicts a reinforcement element wrapped around a spiral wound membrane element 100. The spiral wound membrane element 100 comprises a first edge 104, a second edge 106 and a mixed layer 110. The mixed layer 110 includes membrane sheets, permeate carrier sheets and feed spacer sheets wrapped around a central tube 108. The cross-sectional perimeter of the mixed layer 110 is referred to as an outer layer 112, which extends the length of the spiral wound membrane element 100.

The reinforcement element comprises a wire 20 and, optionally, an outer wrap 50. The wire 20 can be a wire, a filament, cord, rope, yarn, braid, extruded body or the like that has a first end 22, an intermediate region 24 and a second end 26. As shown in FIG. 1, the wire 20 may be wrapped, for example helically wrapped, around the longitudinal axis of the spiral wound membrane element 100. Preferably, the outer layer 112 of the spiral wound membrane element 100 is in fluid communication with the feed spacer sheets in the mixed layer 110. Optionally, a cage is secured around the longitudinal axis of the spiral wound membrane 100 and the wire 20 is wrapped on top of the cage. The cage can be formed of netting, for example polypropylene netting, that is tension wrapped around the spiral wound membrane element. The cage can be fixed to itself, for example by thermal bonding.

The wire 20 can be wrapped in either a clockwise or counter-clockwise manner. During wrapping, the first end 22 can be held at a first edge 104 of the spiral wound membrane element 100, adjacent the outer layer 112. For example, the first end 22 may be attached to an anti-telescoping device, a clamp around the end of the spiral wound membrane element 100, to the central tube 108, or wrapped in a ring around the spiral wound membrane element 100 before beginning to extend along the length of the spiral wound membrane element 100. The intermediate region 24 is then successively wrapped around the longitudinal axis of the spiral wound membrane 100 in a first direction until reaching the second edge 106 of the spiral wound membrane element 100. At this point, the wrapping of the intermediate region 24 changes to a second direction, which is in the opposite direction to the first direction (shown by the dotted line in FIG. 1). Optionally, the wire 20 can be wrapped in a ring around the membrane element 100 or attached to a clamp, an anti-telescoping device or the central tube 108 before changing to the second direction. The successive wrapping of the intermediate region 24 in the second direction continues until the first end 22 and the second end 24 meet and are fixed together, directly or through an intermediate structure, at the first edge 104 of the spiral wound membrane element 100. The fixing of the first end 22 and the second end 24 secures the wrapped position of the wire 20. In this wrapped position, the wire 20 provides a compressive force or resistance to deformation that structurally supports the spiral wound membrane element 100. Optionally, the compressive force causes minor deformities of the spiral wound membrane element 100. The minor deformities can be small regions of the spiral wound membrane element that protrude between the wrappings of the intermediate region 24. These small protruding regions may also assist in securing the wrapped position of the wire 20. Optionally, ultrasonic welding, thermal welding or adhesives may be used to fix the wire 20 to the outer layer 112, or cage as the case may be, that is below the wire 20.

Optionally, the wire 20 is wrapped so that the successive wraps in the first direction are parallel to each other and the successive wraps of the wire 20 in the second direction are parallel to each other. A gap 30 can be maintained between parallel wraps of the wire 20 (the gap 30 is shown as a double sided arrow in FIG. 1). For example, the gap 30 is between each successive wrap of the wire 20 in the first direction and each successive wrap of the wire 20 in the second direction. The gap 30 can be the same, or not, between each successive wrap in the first direction and each successive wrap in the second direction. Further, the gap 30 can be the same, or not, between all successive wraps in the first direction and the second direction. Preferably, the gap 30 is at least equal to, or greater than, the diameter of the wire 20. The gap 30 allows sanitization fluid to access between the parallel wraps of the wire 20.

Wrapping of the wire 20 in both the first and second directions creates a number of intersections 28 where the wire 20 crosses over itself. The wire 20 wrapped in the first direction is wrapped at an angle to the second direction. The angle minimizes the contact area between the wire 20 wrapped in the first and second direction, which can increase sanitization fluid access to intersections 28. The angle may be oblique or acute.

Alternatively, the wire 20 is a series of independent rings that are positioned around the outer layer 112, or the cage, below the wire 20. In this case, the independent rings of the wire 20 can be fixed in position by tension, friction, ultrasonic welding, thermal welding or adhesives or combinations thereof. The independent rings can be distanced apart by the gap 30 that is at least equal to, or greater than the diameter of the wire 20. The independent rings avoid the creation of the intersections 28 and may have less areas of tight tolerance in comparison to the wire 20 that is wrapped in both the first and second direction.

The wire 20 can be made from a variety of suitable materials. For example, the material for the wire 20 may meet food contact standards. Additionally, the material may allow the wire 20 to hold the wrapped position around the spiral wound membrane element 100 without plastically deforming, or otherwise deforming excessively, during filtration operations or when exposed to high temperatures and chemicals during cleaning. The material preferably does not soften or degrade during high temperature and/or other chemical-based sanitization procedures. Chemical-based sanitary procedures include treatment with a high pH solution, a low pH solution, an enzyme solution or an oxidant solution. An example of a suitable material is stainless steel, including 300 series stainless steel.

FIG. 1 depicts the outer wrap 50, partially cut away. The outer wrap 50 is a generally planar body having a first edge 52, a second edge 54, a first side 56 and a second side 58. The outer wrap 50 is wrapped around the wire 20 and the spiral wound membrane element 100, optionally, by fixing the first side 56 to the second side 58. Optionally, the outer wrap 50 can be a heat shrink tube or other forms of deformable sleeves.

The outer wrap 50 may be made from one or more of a variety of deformable materials that meet food contact standards, for example plastic tubes. When the reinforcement member is positioned around the spiral wound membrane element 100, the first edge 52 of the outer wrap 50 may be adjacent to the first edge 104 and the second edge 54 is adjacent the second edge 106. The outer wrap 50 preferably has an outer surface 60 that does not create substantial areas of tight tolerance and provides fluid communication with the wire 20 below. For example, the outer wrap 50 can be a shell, open netting, or a cage made of a micro porous plastic, a micro-porous bonded fiber, or a urethane foam. Optionally, the outer wrap 50 is made from a material that is both deformable and allows fluid passage across the outer wrap 50 to the wire 20 below.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art.

What is claimed is:

1. A spiral wound membrane element, comprising: an outer layer and a wire wrapped around the outer layer.

2. The spiral wound membrane element of claim 1, wherein the wire is made from a rigid material.

3. The spiral wound membrane element of claim 2, wherein the wire is made from stainless steel.

4. The spiral wound membrane element of claim 2, wherein the wire is wrapped around and at least in a first direction along the length of the outer layer.

5. The spiral wound membrane element of claim 4, wherein the wire is wrapped around and in a second direct along the length of the outer layer.

6. The spiral wound membrane element of claim 4, wherein successive turns of the wire are separated by a gap.

7. The spiral wound membrane element of claim 6, wherein the gap is at least as large as the diameter of the wire.

8. The spiral wound membrane element of claim 1, wherein the outer layer is porous.

9. The spiral wound membrane element of claim 1, further comprising an outer wrap.

10. The spiral wound membrane element of claim 9, wherein the outer wrap is made from a material that allows fluid communication through the outer wrap.

11. The spiral wound membrane element of claim 9, wherein the outer wrap is made from a deformable material.

12. The spiral wound membrane element of claim 1, further comprising a cage between the outer layer and the wire.

13. The spiral wound membrane element of claim 1, wherein the wire is a series of independent rings.

14. A method of reinforcing a spiral wound membrane element, comprising a step of wrapping a wire around the membrane element.

15. The method of claim 14, further comprising a step of placing a porous outer wrap around the spiral wound membrane element and wire.
